(19) United States
(12) Patent Application Publication
(10) Pub. No.: US 2016/0142523 A1
(43) Pub. Date: May 19, 2016

(54) MULTI-SLOT MOBILE DEVICE UTILITY STAND

(71) Applicant: Mark Bartkowski, Roaring Brook Twp, PA (US)

(72) Inventor: Mark Bartkowski, Roaring Brook Twp, PA (US)

(21) Appl. No.: 14/542,532

(22) Filed: Nov. 14, 2014

(51) Int. Cl. H04M 1/04; F16B 5/00; F16M 11/22

(52) U.S. Cl. CPC H04M 1/04; F16M 11/22; F16B 5/0004

(57) ABSTRACT

A mobile device utility stand for holding and supporting a mobile device such as a mobile phone as well as documentary material upright in discrete compartments. The mobile device utility stand comprises a zigzag shaped base stand that includes a phone compartment, a front slot and a back slot integrated therein, with the front slot positioned substantially vertical and the phone compartment and back compartment positioned at an angle. The front slot and the back slot each define a double pane structures in which paper or anther substantially flat planar document can be slid.

### BACKGROUND OF THE INVENTION

1. Field of the Invention

This invention relates generally to a support stand and, more particularly, to a portable mobile device stand that includes a plurality of additional compartments for holding documents.

2. Description of the Prior Art

While dining out, many individuals often find difficulty in deciding where to place their mobile devices. Similarly, individuals often struggle with finding a good place for their mobile devices while seated at desk or a table structure generally. Thus, a problem which still exists is that despite mobile devices, such as mobile phones being ubiquitous in today's society, there are few discrete structures suitable for holding a mobile device upright and off a table where they may be exposed to spills or take up too much space. Further, known structures for holding a phone upright often are solely for use with the phone and thus are unlikely to additionally allow for the display of pictures, cards, or other documents along with the phone. Thus, there remains a need for a mobile device utility stand which would allow a mobile device to be displayed upright and off a table. It would be helpful if such a mobile device utility stand to include slots that allowed papers to displayed upright, along with the mobile device, in a discrete compartment. It would be additionally desirable for such a mobile device utility stand to be portable so that it can be deployed by a user in locations where keeping a mobile device upright and/or off a table is desirable.

The Applicant's invention described herein provides for a mobile device utility stand adapted to hold a mobile device and papers upright in discrete compartments. The primary aspects of Applicant's mobile device utility stand are a base stand, a phone compartment, a front slot and a back slot. When in operation, the mobile device utility stand enables a user to store or otherwise hold their mobile device as well as relevant documents safely upright to keep them in view in a space efficient manner. As a result, many of the limitations imposed by prior art structures are removed.

### SUMMARY OF THE INVENTION

A mobile device utility stand for holding and supporting a mobile device such as a mobile phone as well as documentary material upright in discrete compartments. The mobile device utility stand comprises a zigzag shaped base stand that includes a phone compartment, a front slot and a back slot integrated therein, with the front slot positioned substantially vertical and the phone compartment and back compartment positioned at an angle. The front slot and the back slot each define a double pane structures in which paper or anther substantially flat planar document can be slid. In this regard, the phone compartment provides a compartment means for holding a mobile device upright at an angle, the front slot provides a first means for holding a planar structure upright vertically, and the back slot provides a second means for holding a planar structure upright at an angle.

It is an object of this invention to provide a mobile device utility stand which would allow a mobile device to be displayed upright and off a table.

It is another object of this invention to provide a mobile device utility stand that includes slots that allowed papers to displayed upright, along with the mobile device, in a discrete compartment.

It is yet another object of this invention to provide a mobile device utility stand that is portable so that it can be deployed by a user in locations where keeping a mobile device upright and/or off a table is desirable.

These and other objects will be apparent to one of skill in the art.

### BRIEF DESCRIPTION OF THE DRAWINGS

FIG. 1 is a side perspective view of a mobile device utility stand built in accordance with the present invention.

FIG. 2 is a side perspective view of a mobile device utility stand built in accordance with the present invention with a mobile phone placed therein.

FIG. 3 is a side elevational view of a mobile device utility stand built in accordance with the present invention.

### DETAILED DESCRIPTION OF THE INVENTION

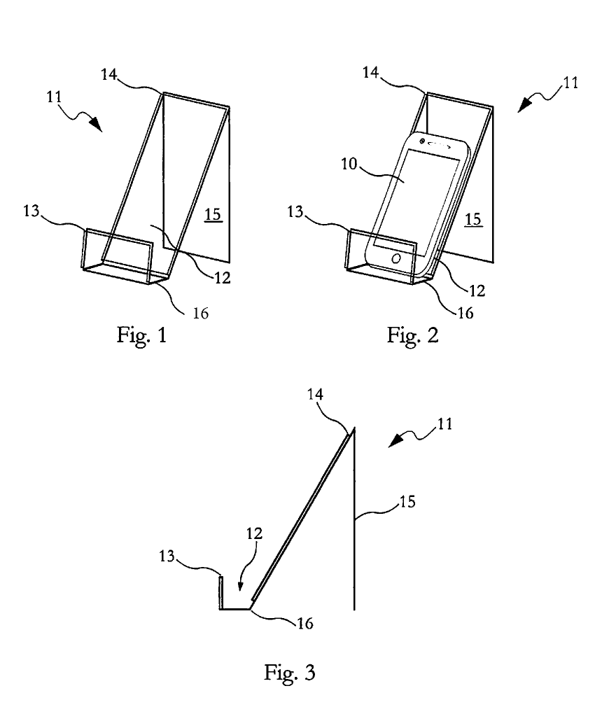

Referring now to the drawings and in particular FIGS. 1, 2, and 3, a mobile device utility stand is shown as a base stand 11 that includes a phone compartment 12, a front slot 13 and a back slot 14. In the preferred embodiment, the base stand 11 is constructed of a rigid, clear plastic. In alternate embodiments, the base stand 11 is constructed of metal and glass or other rigid materials.

The base stand 11 is defined by a substantially zigzag form, with the front slot 13 forming the front section of the base stand 11 and a back wall 15 forming the back section of the base stand 11. From the bottom of the front slot 13 to the bottom of the back slot 14 is a compartment floor 16 that defines the bottom surface of the phone compartment 12 on which the bottom of a mobile device 10 housed in the mobile device utility stand can be placed. The back slot 14 extends up diagonally from the compartment floor 16, forming a back surface of the phone compartment 12 on which the back of a mobile device 10 housed in the mobile device utility stand can rest against while in an upright position. At the top of the back slot 14 the back wall 15 extends downward and terminates such that its lowest point forms a flat plane with the underside of the compartment floor 16. In this regard, the underside of the compartment floor 16 and the lowest point of the back wall 15 form a two point support structure that holds the mobile device utility stand upright when placed on a flat surface.

The front slot 13 and the back slot 14 each define a double pane structures in which paper or anther substantially flat planar document can be slid. In the preferred embodiment, the front slot 13 is sized to hold business cards, restaurant special cards and other smaller documentary material while the back slot is sized to hold menus or other larger documentary material. It is contemplated that in each embodiment, the front pane of the front slot 13 and the back slot 14 are constructed of transparent material.

The instant invention has been shown and described herein in what is considered to be the most practical and preferred embodiment. It is recognized, however, that departures may be made therefrom within the scope of the invention and that obvious modifications will occur to a person skilled in the art.

1. A mobile device utility stand for holding materials upright on a flat surface, comprising:
a rigid base stand having a flat front panel, a flat bottom panel, a flat back panel and a support member, wherein said front panel, flat bottom panel, flat back panel, and support member of the base stand are connected in a zigzag form with the one end of the front panel angularly connected to one end of said bottom panel, one end of the back panel angularly connected to an end of said bottom panel that is opposite the end of the bottom panel connected to front panel, and one end of the support member angularly connected to an end of said back panel that is opposite the end of the back panel connected to bottom panel;
said front panel, bottom panel, and back panel forming a phone compartment with the back panel defining an angularly disposed back surface against which the back surface of a mobile device housed in the mobile device utility stand can rest against in an upright position;
said front panel being positioned in front of the phone compartment and including a flat front slot integral therewith, wherein said front slot is configured to slidingly receive and then hold a discrete, flat planar structure in an upright position; and
said back panel including a flat back slot integral therewith, wherein said back slot is configured to slidingly receive and then hold a discrete, flat planar structure in an upright position.

2. (canceled)

3. The mobile device utility stand of claim 1, wherein said front panel is positioned orthogonally relative to said bottom panel and the front slot is oriented so as to hold a discrete, flat planar structure in an upright vertical position.

4. The mobile device utility stand of claim 3, wherein said back panel is positioned at an obtuse angle relative to said bottom panel.

5. (canceled)

6. The mobile device utility stand of claim 1, wherein the front panel includes a transparent portion.

7. (canceled)

8. The mobile device utility stand of claim 1, wherein the back panel includes a transparent portion.

9.-17. (canceled)

18. The mobile device utility stand of claim 1, wherein said support member is positioned at an acute angle relative to said back panel.

19. A mobile device utility stand for holding materials upright on a flat surface, comprising:
a rigid base stand having a flat front panel, a flat bottom panel, a flat back panel and a support member, wherein said front panel, flat bottom panel, flat back panel, and support member of the base stand are connected in a zigzag form with the one end of the front panel angularly connected to one end of said bottom panel, one end of the back panel angularly connected to an end of said bottom panel that is opposite the end of the bottom panel connected to front panel, and one end of the support member angularly connected to an end of said back panel that is opposite the end of the back panel connected to bottom panel;
said front panel, bottom panel, and back panel forming a phone compartment with the back panel defining an angularly disposed back surface against which the back surface of a mobile device housed in the mobile device utility stand can rest against in an upright position;
said front panel being positioned orthogonally relative to said bottom panel, in front of the phone compartment, and including a flat front slot integral therewith that is configured to slidingly receive and then hold a discrete, flat planar structure in an upright vertical position;
said back panel being positioned at an obtuse angle relative to said bottom panel and including a flat back slot integral therewith that is configured to slidingly receive and then hold a discrete, flat planar structure in an upright angular position;
said support member being positioned at an acute angle relative to said back panel and
said front panel and said back panel each including a transparent portion.
